(19) United States
(12) Patent Application Publication
(10) Pub. No.: US 2004/0230482 A1
(43) Pub. Date: Nov. 18, 2004

(54) Real-time point-of-sale marketing system

(76) Inventor: Robert J. Hendrickson, Sea Girt, NJ (US)

Correspondence Address: KATTEN MUCHIN ZAVIS ROSENMAN, 575 MADISON AVENUE, NEW YORK, NY, 10022-2585, US

(21) Appl. No.: 10/775,752

(22) Filed: Feb. 9, 2004

Related U.S. Application Data
(60) Provisional application No. 60/445,781, filed on Feb. 7, 2003.

(51) Int. Cl. G06F 17/60

(52) U.S. Cl. 705/14

(57) ABSTRACT

A method for making a promotional offer by a seller to a customer as the customer visits a Point-of-Sale (POS) or retail outlet. First, the customer is identified as being present in the outlet. A promotional offer is selected from an offer inventory and presented to the customer in real-time while the customer is present in the POS outlet. The promotional offer is selected as a function of an offer cost and an anticipated return on investment (ROI) of the offer. Subsequent purchase activities of the customer are tracked to re-evaluate anticipated ROI for the offer, to adjust offer inventories and to correlate the effectiveness of the promotional offer with other customer-directed marketing activities.

### CROSS-REFERENCE TO RELATED APPLICATION

The present application claims priority under 35 U.S.C. § 119(e) from U.S. Ser. No. 60/445,781, entitled “Real-Time Point-Of-Sale Marketing System,” filed on Feb. 7, 2003. U.S. Ser. No. 60/445,781 was filed by an inventor common to the present application, and is hereby incorporated by reference.

### FIELD OF THE INVENTION

The present invention provides a method for directly marketing products and services to customers at individual and multiple point-of-sale and retail outlets (collectively, “POS outlets”).

### BACKGROUND OF THE INVENTION

A variety of traditional marketing and promotional methods have been employed to encourage customers to visit and make purchases at POS outlets. Broadcast advertising has been delivered through a variety of media (for example, television, radio, general mail and newspapers) to alert potential customers to promotional sales and other opportunities at POS outlets. More targeted mailings have been directed to identified customer groups (for example, frequent POS outlet visitors) and other identified groups of potential customers (for example, holders of a preferred credit card living within a predetermined distance from the POS outlet). Historically, these methods have tended to produce low response rates (often single-digit percentages at best).

The prior art methods suffer from not being well-matched to specific interests and needs of individual customers, and from being removed in time from the customer's in-outlet purchasing experience.

Marketing and promotional efforts directed to specific customer interests and needs at or near the time of purchase would be expected to produce far superior results. For example, a number of Internet sites currently present customers with personalized marketing at the time of visit that is based on the customer's past purchasing history (for example, AMAZON.COM). However, to date, no one has created a personalized, direct marketing experience for customers at the time they are physically visiting a POS outlet.

### SUMMARY OF THE INVENTION

A method is disclosed for making a promotional offer by a seller to a customer as the customer visits a POS outlet. The method comprises the steps of identifying the customer as being present in the POS outlet, selecting a promotional offer from an offer inventory including at least one of a product offer and a service offer, and presenting the promotional offer to the customer while the customer is present in the POS outlet. The promotional offer is selected from the offer inventory based on at least one identified characteristic of the customer. The offer may be presented using one of a variety of presentation means (for example, by a human host, via in-outlet electronic signage, or via personal electronic means such as the customer's pager, personal digital assistant (PDA), or cellular telephone, and the like). The presentation means may also be selected based on the at least one identified characteristic of the customer, or based on other customer information (for example, using in-outlet signage when the customer if the customer is in physical proximity to the signage).

In addition, in a preferred embodiment of the invention, the promotional offer selection and presentation means are selected by evaluating an anticipated cost and return on investment. Subsequent purchases and other in-outlet and associated activities of the customer are tracked to re-evaluate anticipated ROI produced by the promotional offer, to adjust offer inventories, and to correlate the effectiveness of the promotional offer with other customer-directed marketing activities.

### BRIEF DESCRIPTION OF THE DRAWINGS

A more complete understanding of the invention may be obtained by reading the following description of specific illustrative embodiments of the invention in conjunction with the appended drawing in which:

FIG. 1 provides a schematic diagram illustrating the inventive method.

### DETAILED DESCRIPTION OF THE PREFERRED EMBODIMENTS

The following detailed description includes a description of the best mode or modes of the invention presently contemplated. Such description is not intended to be understood in a limiting sense, but to be an example of the invention presented solely for illustration thereof, and by reference to which in connection with the following description and the accompanying drawing one skilled in the art may be advised of the advantages and construction of the invention.

The present invention provides a real-time, personalized marketing experience for customers visiting a POS outlet. According to the method disclosed by the present invention, means are provided for recognizing a customer upon entry to the POS outlet, or upon reaching a designated position in the outlets, either individually or as a member of a customer group of interest. Such means may unobtrusively include, for example, image recognition systems, voice response and recognition systems, credit card readers and identification badge recognition systems.

Customer groupings are based on individual and/or group demographics and profiles, customer product and service interests (for example, based on past purchase histories, or on predicted future purchase potentials), position in customer loyalty marketing programs, and/or purchasing likelihoods and levels. As disclosed for example by U.S. Pat. No. 6,003,013 to Boushy et al., which is hereby incorporated by reference, customers may be categorized into defined groups (for example, including new customers of potential high worth, existing customers making high-worth purchases, existing customers nearing high-worth in purchases, existing customers formerly making high-worth purchases, and other customers).

Once customers have been identified in a POS outlet “space”, the method operates to track customer behavior within that space. Purchases made and product/service display areas visited are readily tracked. In addition, customer interactions and interactive requests with sales personnel and other customer information systems (for example, product demonstration systems or information kiosks) may be tracked, including new and updated individual information demographic and profile data. According to the method, the tracked information is then used to update customer histories, and to update and enhance the customer categorizations, including updating the customer's profile and/or contact management records that may be included in a customer information database (CIB). It should be noted that CIB's are presently used widely by sales entities (in particular, by Internet sales entities). As construction and use of CIBs is accordingly well known in the art, no further exposition of CIBs is provided herein. In-outlet information collected and stored in a CIB may also be correlated with external marketing and promotional offers, and other external customer contacts.

Based on customer categorizations, the method then interacts with product and sales inventory information systems to identify possible product and service offers to be made to the recognized customers while in the space, in accordance with customer interests and needs. Offers are evaluated, for example, on the basis of an expected return on investment (ROI) to the outlet. The expected ROI may be based on a prediction of the level and likelihood of correlated purchases, both within the present outlet, or in other outlets owned by or otherwise associated with the present outlet owner, that would be stimulated in the customer by the offer, as compared to the effective cost of the offer. It should be noted that the effective cost of providing some offer items may be extremely low (for example, in the cases of excess inventory at the end of a buying season or unsold seats at a theatrical performance), thereby generating the possibility of a substantial ROI for the outlet. The expected ROI may also be based on a prediction of the impact on the level and likelihood of future purchases, both in an individual outlet as well as across multiple outlets.

In accordance with the inventive method, means are then provided for presenting offers to customers. Such means may include human hosts who are dispatched to interact with the customers, personalized signage within the space that presents personalized offer information to the customer when the customer is within a certain proximity, and other personal electronic means (for example, including the customer's pager, personalized digital assistant (PDA), and cell phone). As a result, marketing-based offers are made in a targeted manner to customers in real-time while they are engaged in the shopping experience. Such offers are expected to generate a much higher success rate and ROI than traditional offers that are less targeted and temporally removed from the customer's shopping experience.

Specific offer presentation means may be selected based on identified customer characteristics, interests and needs. For example, customers identified as having an interest in personal electronic devices may receive a promotional offer via a PDA rather than via a human host, customers identified as hearing-impaired may be received an offer from a host who is able to sign, and customers positioned near an in-outlet electronic information kiosk may received an offer from the kiosk. Related means are also provided to enable customers to accept and claim the offers.

In addition to providing offers to customers within the space, the inventive method provides for tracking associated offers made outside the space (for example, a targeted sales offer mailed a week after the customer makes an in-outlet purchase) so that these associated offers may be correlated with in-outlet purchases and shopping behaviors. This mechanism allows the associated offers to be evaluated and fine-tuned. In-outlet behaviors may also be correlated, for example, with on-line marketing and purchase activities. This may be helpful, for example, for distinguishing products and services offered at the POS outlet from products and services more effectively offered on line, and/or through the mail, or any other external to the outlet means. Presentation and acceptance means may also be evaluated in this manner.

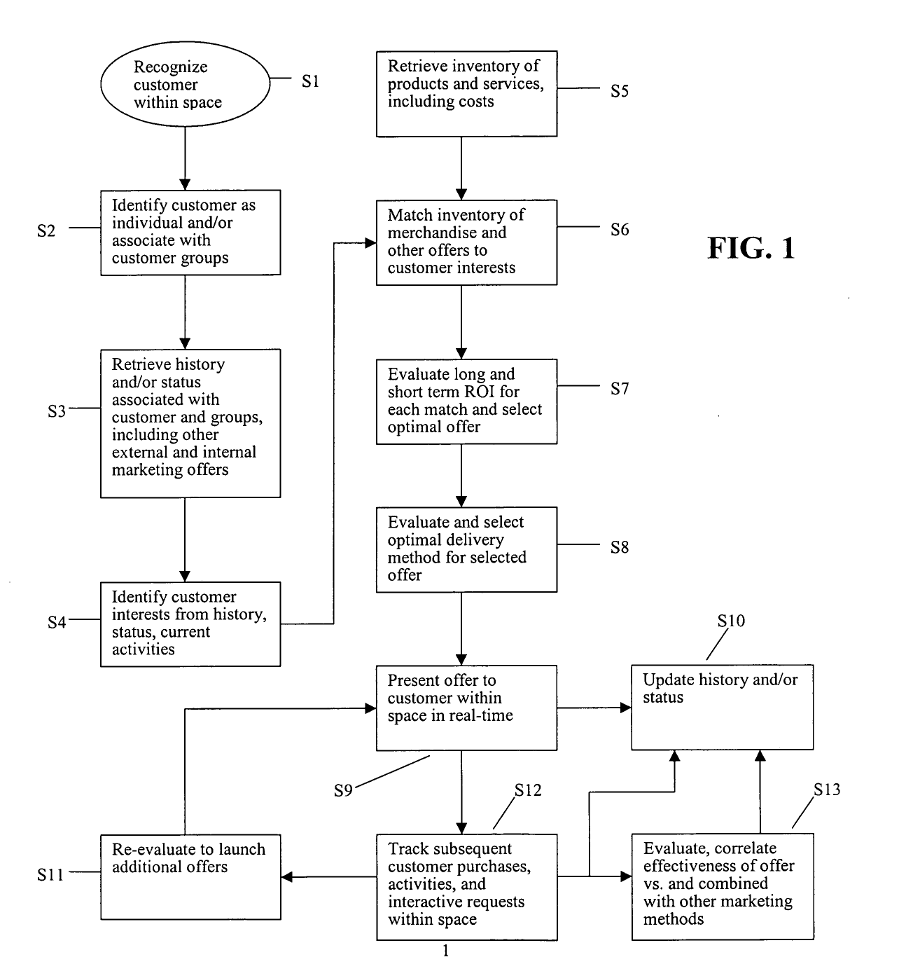

FIG. 1 illustrates the principal elements of the inventive method 100 and their interrelationships. At step S1, as customer is recognized as being present within the POS outlet space. As previously noted, recognition may be made at a variety of identifiable location in the outlet using such means as image recognition systems, voice response and recognition systems, credit card readers and identification badge recognition systems.

At step S2, the customer is identified according to the customer's individual identity, and/or in association with one or more predetermined customer groups. At step S3, history and status information is retrieved, for example, from a customer information database (CIB), for the identified customer/customer groups. As previously noted, such CIBs are currently employed by a number of Internet sites, as well as by more conventional retailers, and are well known in the art.

The retrieved history and status information can be used to identify, for example, other associated promotional offers previously made to the customer. In addition, as indicated at step S4, the retrieved history and status information in combination with current activity information is used to identify customer interests.

At step S5, offer inventory information is retrieved from an offer inventory, identifying available product and service offers and their associated costs. From the offer inventory, at step S6, offers are matched to the identified customer interests. At step S7, a short term and long term anticipated return on investment (ROI) from the customer are forecast for each offer match, and an optimal match is selected on the basis of the anticipated ROI and associated cost for each offer match.

At step S8, available offer delivery methods are evaluated, and an optimal delivery method is selected for presenting the selected offer to the customer. The optimal delivery method is selected based on identified customer interests and needs, preferably on the basis of the effect of the selected presentation method on anticipated ROI and associated cost.

At steps S9, the selected offer is presented via the selected delivery method to the customer within the space of the POS outlet and in real-time. At steps S12 and S10, after the offer has been presented to the customer, information about subsequent in-outlet activities of the customer (for example, purchases) may be tracked for retention in the CIB. Information relating to other customer activities (for example, queries to an Internet web-site of the outlet) may preferably also be tracked for retention in the CIB. At step S11, such information may preferably be used to revaluate and adjust product and service offers in the inventory. At step S12, the information is used to correlate in-outlet offer activities, for example, with other marketing activities (for example, follow-up direct mail and Internet offers) and evaluate the overall effectiveness of the combined marketing efforts.

In summary, the inventive method advances the art by providing a method for POS outlets to provide targeted marketing to customers in real-time while they are engaged within the POS outlet space. Importantly, the method provides a means for selective product and service offerings to be identified based on customer interests and needs, and then evaluated based on expected ROI to the outlet. In this manner, the outlet may be able to both increase the volume of sales generated by customers visiting the outlet, as well as reduce the costs associated with generating this added sales volumes. In addition, the outlet may able to evaluate and adjust associated marketing activities outside the outlet space by correlating the effects of these external marketing activities with in-outlet customer behaviors.

The foregoing describes the invention in terms of embodiments foreseen by the inventor for which an enabling description was available, notwithstanding that insubstantial modifications of the invention, not presently foreseen, may nonetheless represent equivalents thereto.

1 A method for making a promotional offer by a seller to a customer in a point-of-sale (POS) outlet, the method comprising the steps of:
recognizing the customer as being present in the POS outlet;
determining an identity of the recognized customer;
selecting the promotional offer from an offer inventory, the offer inventory including at least one of a product offer and a service offer of the seller; and
presenting the promotional offer to the customer while the customer is present in the POS outlet;
wherein the promotional offer is selected based on at least one characteristic associated with the customer identity.

2 The method of claim 1, wherein the customer identity is determined using individual identification means coupled to a customer database.

3 The method of claim 2, wherein the individual identification means is selected from the group consisting of image recognition means, voice recognition means, and card recognition means.

4 The method of claim 3, wherein the card recognition means recognizes at least one of credit cards and identification badges.

5 The method of claim 2, wherein the customer identity includes an individual customer identity.

6 The method of claim 2, wherein the customer identity includes at least one of a plurality of predetermined customer groups.

7 The method of claim 6, wherein the plurality of predetermined customer groups are defined according to at least one of product types offered by the seller, service types offered by the seller, purchase levels of the customer and other customers, purchase frequencies of the customer and the other customers, and term of relationship between seller and customer and seller and other customers.

8 The method of claim 2, further comprising the step of retrieving customer information associated with the customer identity from the database.

9 The method of claim 8, wherein the retrieved customer information includes at least one of customer purchase information and customer interest information.

9 The method of claim 8, wherein the at least one identified characteristic is determined based on the retrieved customer information.

10 The method of claim 9, wherein the at least one identified characteristic is determined based on customer information relating to activities undertaken by the customer in the POS outlet.

11 The method of claim 10, wherein the customer information relates to at least one of areas of the POS outlet visited by the customer and purchases made in the POS outlet by the customer.

12 The method of claim 10, wherein the customer information relating to activities undertaken by the customer in the POS outlet is stored in the customer database.

13 The method of claim 8, wherein the selecting step further comprises step of:
evaluating a plurality of promotional offers in the inventory as a function of an offer cost and an anticipated return on investment (ROI).

14 The method of claim 13, wherein the anticipated ROI is evaluated based on the retrieved customer information.

15 The method of claim 8, wherein the retrieved customer information includes information indicating one or more preferred offer presentation modes of the customer.

16 The method of claim 15, wherein the preferred offer presentation modes are selected from the group consisting of offer presentations by a POS outlet host, offer presentations made by in-outlet electronic means and offer presentations made electronically via personal electronic means.

17 The method of claim 16, wherein the in-outlet electronic means are selected from the group including kiosks, interactive product displays and electronic signage.

18 The method of claim 16, wherein the personal electronic means is selected from the group including pagers, personal digital assistants, and cellular telephones.

19 The method of claim 2, further comprising the step of tracking interactions between the customer and the seller occurring subsequent to the presenting step.

20 The method of claim 19, wherein the interactions tracked include at least one of product sales between the seller and the customer and service sales between the seller and the customer.

21 The method of claim 19, wherein customer information relating to the tracked interactions is store in the customer database.

22 The method of claim 19, wherein the promotional offer is evaluated as a function of customer information relating to the tracked interactions.

23 The method of claim 19, wherein the subsequent interactions tracked include interactions between the customer and the seller occurring in the POS outlet following the presenting step.

24 The method of claim 16, wherein an offer presentation mode is selected as a function of customer interests and needs, said mode selected to be optimal as to an anticipated return on investment (ROI) and an associated cost.
